(19) United States
(12) Patent Application Publication
(10) Pub. No.: US 2016/0189485 A1
(43) Pub. Date: Jun. 30, 2016

(54) GAMING APPARATUS AND SYSTEMS

(71) Applicant: Dynamite Services Pty Limited, Sydney (AU)

(72) Inventor: Benjamin James Ellis, Sydney (AU)

(21) Appl. No.: 14/949,433

(22) Filed: Nov. 23, 2015

Related U.S. Application Data
(63) Continuation of application No. 14/843,260, filed on Sep. 2, 2015.
Application No. 14/843,260 is a continuation-in-part of application No. 13/718,177, filed on Dec. 18, 2012, now Pat. No. 8,665,990.

(30) Foreign Application Priority Data
Sep. 2, 2014 (AU) 2014221197

(51) Int. Cl. G07F 17/32

(52) U.S. Cl. CPC G07F 17/3267; G07F 17/3255

(57) ABSTRACT

A method of gaming comprises displaying play of a wager game having a plurality of stages with progression through the stages being dependent on a predefined gameplay criterion. Each of the stages is associated with a feature event that is awardable to the player in response to a trigger event being detected. In response to determining that a trigger for a particular stage has occurred, the feature event associated with the particular stage as well as the feature event(s) associated with any preceding stages are awarded to the player.

### FIELD OF THE INVENTION

The present invention relates to gaming systems, game controllers and methods of gaming. It relates for example to electronic gaming machines and to networked gaming systems, such as Internet-based gaming systems.

### BACKGROUND OF THE INVENTION

Gaming machines have been a popular form of entertainment for many years. This popularity has been enhanced with the advent of electronic gaming machines and computer-based gaming systems, such as are provided over the Internet.

Many different types of game are playable on such gaming machines. They include for example standard slot-machine type games with spinning reels, poker machines, keno, bingo, blackjack, roulette, pachinko and the like.

A user will typically place a bet to begin a game, and will win or lose based upon the rules of the game.

While such games provide users with enjoyment, the need exists for alternative gaming systems in order to maintain or increase player enjoyment.

### SUMMARY OF THE INVENTION

According to a first aspect of the invention there is provided a method of gaming comprising:
displaying play of a wager game having a plurality of stages with progression through the stages being dependent on a predefined gameplay criteria, each of the stages being associated with a feature event that is awardable to the player in response to a trigger event being detected;
in response to determining that a trigger for a particular stage has occurred, awarding the feature event associated with the particular stage as well as the feature event(s) associated with any preceding stages.

In an embodiment the method further comprises resetting play of the game to a first stage upon the feature event(s) being awarded.

In an embodiment a value or potential value of the feature event increases with each stage.

In an embodiment the predefined gameplay criteria is that a particular game outcome has been achieved during play of the respective stage. For example, the particular game outcome may be that a particular trigger or symbol combination has or has not occurred.

In an embodiment the predefined gameplay criteria is that a predefined amount of gameplay has occurred.

In an embodiment the predefined amount of gameplay is associated with at least one of the number of games played by the player and an accumulated wager amount for a predefined period of gameplay.

In an embodiment the method further comprises forcing the feature event to be awarded in the final stage of the game after a predefined amount of gameplay has been reached without the trigger occurring.

In an embodiment the method further comprises awarding the feature event(s) in succession.

In an embodiment a play parameter for an awarded feature event is set in dependence on at least one of a number of stages that have been played at the time the trigger was detected and a characteristic of a feature event associated with a previous stage.

In an embodiment a play parameter for a feature event associated with one of the stages is different to a play parameter for a feature event associated with another one of the stages.

In an embodiment the feature event for each of the stages is the awarding of a number of free games.

In an embodiment the number of free games awarded progressively increases with each stage.

In an embodiment the method further comprises requiring a player to place a wager which is supplementary to a wager placed on the game in order to be eligible to be awarded one or more of the feature events in response to a single determination that a trigger for a particular stage has occurred. The supplementary wager may be required in order to be awarded the feature events in succession, in response to the single trigger determination.

In an embodiment the trigger event differs for at least one of the stages in comparison to another stage.

In accordance with a second aspect there is provided a method of gaming comprising:
displaying play of a wager game having a plurality of stages with progression through the stages by a player being dependent on meeting a predefined amount of gameplay without having triggered a feature event; and
in response to determining that a feature event has triggered in a particular stage, awarding the feature event associated with the particular stage as well as the feature event(s) associated with any preceding stages.

In accordance with a third aspect of the present invention there is provided a gaming apparatus comprising:
a display module operable to display play of a game having a plurality of stages with progression through each stage being dependent on a predefined gameplay parameter, each of the stages being associated with a feature event that is awardable to the player in response to a trigger event being detected;
an award module operable to monitor for the occurrence of the trigger event and in response thereto award the associated feature event as well as awarding the feature event(s) for any preceding stages.

In an embodiment the apparatus further comprises a reset module operable to reset play of the game to a first stage upon the feature event(s) being awarded.

In an embodiment a value or potential value of the feature event increases with each stage.

In an embodiment the predefined gameplay criteria is that a particular game outcome has been achieved during play of the respective stage.

In an embodiment the predefined gameplay criteria is that a predefined amount of gameplay has occurred.

In an embodiment the predefined amount of gameplay is associated with at least one of the number of games played by the player and an accumulated wager amount for a predefined period of gameplay.

In an embodiment the award module is further operable to force the feature event to be awarded in the final stage of the game after a predefined amount of gameplay has been reached without the trigger occurring.

In an embodiment the award module is operable to award the feature event(s) in succession.

In an embodiment a play parameter for an awarded feature event is set in dependence on at least one of a number of stages that have been played at the time the trigger was detected and a characteristic of a feature event associated with a previous stage.

In an embodiment a play parameter for a feature event associated with one of the stages is different to a play parameter for a feature event associated with another one of the stages.

In an embodiment the feature event for each of the stages is the awarding of a number of free games.

In an embodiment the number of free games awarded progressively increases with each stage.

In an embodiment the apparatus further comprises a player input module operable to receive a player wager which is supplementary to a wager placed on the game for allowing the player to be eligible to be awarded the feature event or a particular aspect of the feature event.

In accordance with a fourth aspect of the present invention there is provided a gaming apparatus comprising:
a display module operable to display play of a game having a plurality of stages with progression through each stage being dependent on meeting a predefined amount of gameplay without having triggered a feature event;
an award module operable to monitor for the occurrence of the feature event trigger event and in response thereto award the associated feature event as well as awarding the feature event(s) for any preceding stages.

In accordance with a fifth aspect of the present invention there is provided a gaming system comprising:
a gaming terminal implementing a display; and
a gaming controller comprising: a display module operable to cause the gaming terminal display to display play of a game having a plurality of progressive stages with progression through each stage being dependent on a predefined gameplay parameter, each of the stages being associated with a feature event that is awarded to the player in response to a trigger event being detected; and
an award module operable to monitor for the occurrence of the trigger event and in response thereto award the associated feature event as well as awarding the feature event(s) for any preceding stages to the gaming terminal.

In accordance with a sixth aspect there is provided a computer program code which when executed by a computing system implements the method as described in accordance with any one of the aforementioned aspects.

In accordance with a seventh aspect there is provided a computer readable medium comprising the computer program code of the sixth aspect.

An embodiment of the system further includes a central control for running a gaming algorithm, and a plurality of remote clients in communication with the central control over a communications network, the remote clients including screens for the display of information to players.

Embodiments of the present invention may be applied to any suitable type of gaming system or platform. It can apply to stand-alone gaming apparatus, e.g. electronic gaming machines, such as video gaming machines, to gaming machines that are linked together, e.g. via a network such as an intranet, and/or to gaming systems provided through computing or other electronic devices, e.g. personal computers, PDAs, mobile telephones, digital televisions, and the like, e.g. over the Internet or other communications networks.

Embodiments may be applied to gaming apparatus that play any suitable game, but especially relate to slot-machine type games.

In some networked embodiments of the invention, the central control may conduct the games and manage the accounting and the like, and a number of remote terminals/clients merely provide the user input and display mechanisms. In other networked embodiments of the invention, the control of the games and various other features may be carried out at the remote terminals, or may be split between the central control and the remote terminals.

### BRIEF DESCRIPTION OF THE ACCOMPANYING DRAWINGS

Embodiments of the invention will hereafter be described, by way of example only, with reference to the accompanying drawings, in which:

FIG. 1 is a block diagram of gaming apparatus according to one embodiment of the present invention;

FIG. 2 is a schematic of a game controller according to an embodiment; and

FIG. 3 is a flow diagram of a gaming control process in accordance with an embodiment of the present invention.

### DETAILED DESCRIPTION

In an embodiment a game controller of a gaming device comprises a display module operable to provide the display of a game having a plurality of stages, with progression through each stage being dependent on a predefined gameplay parameter, each of the stages being associated with a feature event that is awardable to the player in response to a trigger event being detected. An award module monitors for the occurrence of the trigger event and in response thereto awards the associated feature event, as well as awarding the feature event(s) for any preceding stages.

### General Construction of a Gaming System

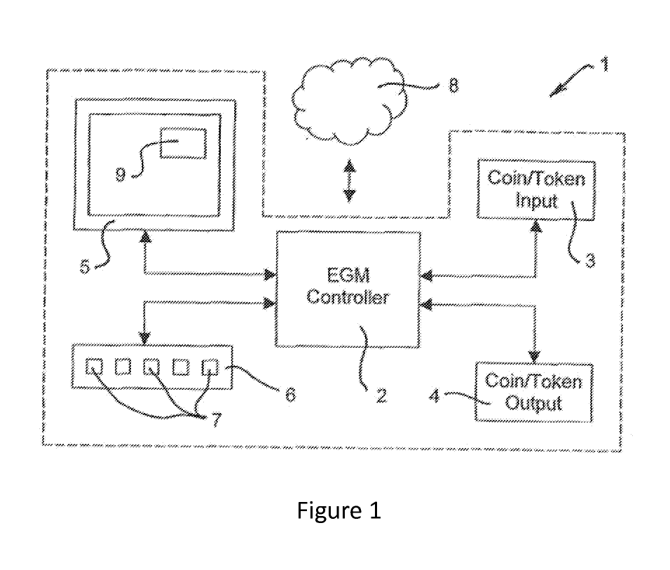

Referring to FIG. 1 there is shown a gaming apparatus, which in this case takes the form of an electronic gaming machine (EGM) 1, and which includes various standard components, such as a game controller 2 for controlling the operation of the EGM 1 and the games run on it, a note/coin/token input 3 for receiving bets, a note/coin/token output 4 for paying out winnings, one or more displays 5 for displaying game screens, and player input means 6 for allowing user interaction, which may include e.g. buttons 7 and which may e.g. be provided as part of the display 5 in a touch-screen type manner. The EGM 1 also includes a player tracking and marketing means 9 having a reading device (e.g. a card scanner for reading a smart card or other form of portable storage medium capable of being read by the card scanner) which communicates with a remote server for providing player tracking and loyalty type functions, as is well understood in the art. Additional hardware may be included as part of the EGM 1, or hardware may be omitted as required by the specific implementation.

In one form the EGM 1 may be a stand-alone machine. In another form, the EGM may be networked with other EGMs and/or a control centre via a suitable communications network 8, such as a LAN and/or WAN, in order to play networked (e.g. intranet or Internet) games, such as a linked jackpot. It will be appreciated that the EGM 1 may include an appropriate communications interface, such as a network card, for communicating over the communications network 8.

In use, the EGM 1 will display an initial gaming screen on the display 5. A player will insert bank notes, coins and/or tokens into the EGM input 3 (or may be credited with coins, credits or tokens), and will press a button 7 to initiate play of the main game provided by the EGM 1. How matters then proceed will depend on the type of main game being played. For example, FIG. 4 illustrates a game screen from a slot machine-type game, in which the EGM 1 displays virtual reels 10 of symbols 11, and spins and stops these reels 10 in various win and lose symbol combinations on one or more paylines 12 in accordance with a stored gaming algorithm and a random number generator. In an alternative embodiment (not illustrated) the main game is a poker-type game, in which a player will receive a number of cards with which to play for a winning hand. It will be appreciated that other types of main games may be provided, such as keno, blackjack, bingo, roulette, pachinko, or the like. For the purposes of this detailed description, the main focus shall be upon an embodiment providing a slot machine-type main game. As used in this document, including in the claims, the terms “random”, “randomly”, “randomized”, and the like, are to be construed as connoting either a purely random process or a “pseudo-random” process. An example of a pseudo-random process includes the determination by a computer processor of a pseudo-random number in response to an output of a digital clock.

The player may interact via the buttons 7, so as e.g. to spin or hold reels and otherwise play the main game. A common element will be win events, e.g. particular symbol combinations that pay out a prize.

Also, in order to increase interest, the main game is capable of providing feature events that consist of one or more feature games, which may or may not relate directly to the main game being played, and that generally provide a prize of some sort. These feature events may include for example one or more free games, a re-spin (similar to a free game but with one or more reels held on a slot device), and the chance to play for higher winnings or the like (e.g. in a higher-payout game that may require additional wagering). They may be e.g. luck or skill based. They may be provided as “second screen” features that display on a new screen, and may be extraneous to the main game and may involve some form of player interaction.

Another way of adding gaming interest is for a main game or a feature event to include one or more wild symbols that can represent more than one type of symbol, and so can increase the chances of achieving a winning combination or the like. Similarly, for embodiments in which the main game is a card game, wild cards may be provided.

These win and feature events can be arranged to occur due to the usual operation of the main game randomly or under a particular set of circumstances, e.g. when a predefined symbol combination occurs after a spin of the reels, or a predefined card combination occurs in a card game. They may also occur due to an accumulation of circumstances across a number of games, and may occur due to the condition of a device supplemental to the EGM 1 itself, e.g. they may relate to jackpot wins in linked jackpot systems comprising a plurality of EGMs under a central control.

FIG. 1 illustrates an essentially stand-alone EGM (albeit with the potential for networked connectivity). However, in an alternative embodiment the system may be implemented over a distributed architecture where some of the individual EGM modules are implemented remotely. For example, in one particular form, a central control computer which is located remotely of the EGM may implement a controller which controls some or all of the game play functionality (i.e. such that the EGM essentially operates as a remote client arranged to provide audible and/or visual gaming information to a player and allow player interaction with the central control computer). A plurality of EGM clients may be in communication with the central control computer over a communications network such as a local area network and/or a wide area network. In an alternative embodiment, the game play functionality may be implemented by both the EGM and central control computer such that they collectively provide a game controller.

The central control computer has access to associated memory and storage devices. The central control computer also has access to computer executable code for instructing the central control computer to run the gaming algorithm that performs the embodiment of the inventive method. In one embodiment the computer executable code is in the form of software and associated data, which are stored upon a computer-readable medium in the form of one or more compact disks.

Alternative embodiments make use of other forms of digital storage media, such as Digital Versatile Discs (DVD's), hard drives, flash memory, Erasable Programmable Read-Only Memory EPROM, and the like. Alternatively, the software and its associated data may be stored as one or more downloadable or remotely executable files that are accessible via a computer communications network such as the internet.

### Detail of the Game Controller

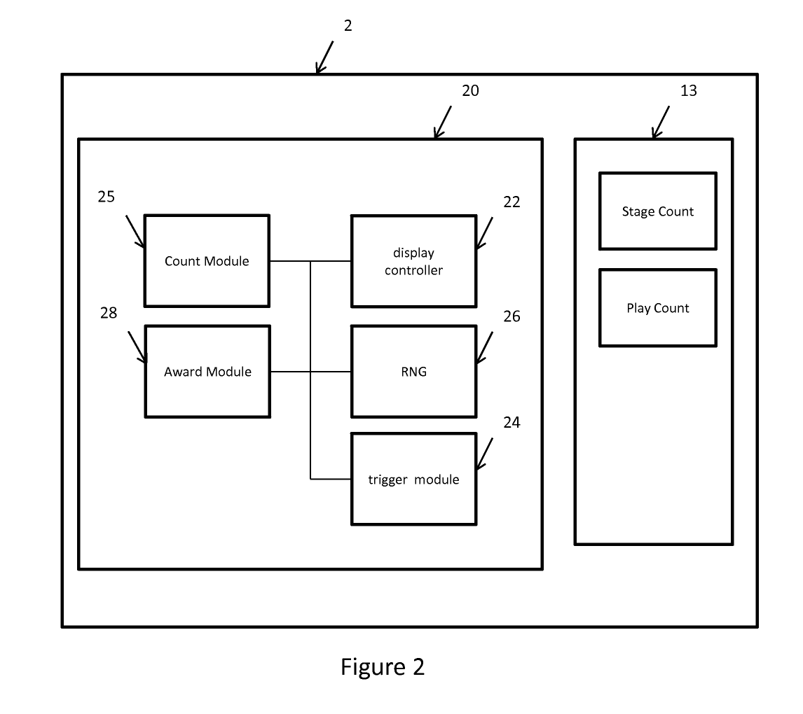

The game controller 2 of an embodiment is shown in more detail in FIG. 2. For simplicity only those modules (which may be implemented in hardware, software, or a combination of the two) needed to carry out embodiments are illustrated. Other standard and/or non-standard modules may also be implemented for carrying out operation of normal and feature game play functionality. It will be understood that the term “processor” as used herein is to be construed broadly and include within its scope any device that can process gaming algorithms and may include a microprocessor, microcontroller, programmable logic device or other computational device, a general purpose computer, or a server computer. Typically, the gaming algorithms (instructions) are stored as program code in memory 13, which is in data communication with the processor.

In the illustrated embodiment, the game controller 2 includes a processor 20 which is arranged to control play of a game having a plurality of stages, with progression through each stage being dependent on some predefined gameplay criteria (e.g. such as a predefined game outcome occurring, not occurring, etc.). The multi-stage game implements an enhanced feature structure whereby players may be awarded multiple feature events in response to a single trigger occurring. More specifically, during each game stage, a feature event associated with that stage is capable of being triggered (either randomly or due to a particular set of circumstances), with a value or potential value of the feature event increasing with each stage. In response to detecting the trigger in a particular stage, the player is awarded the feature event associated with that stage as well as being awarded the feature event(s) associated with any preceding stages.

To facilitate the above functionality, the processor 20 implements a number of modules, based on program code stored in memory 13. A display module 22 is operable to provide the display of the multi-stage game implemented by the controller 2. A trigger module 24 is arranged to set randomly occurring feature event triggers and detect their occurrence during play of the game, with the aid of a random number generator 26. A count module 25 keeps track of spin (or play) count and stage count. An award module 28 is operable to award feature events in the manner described above upon the trigger module 24 determining the occurrence of a trigger.

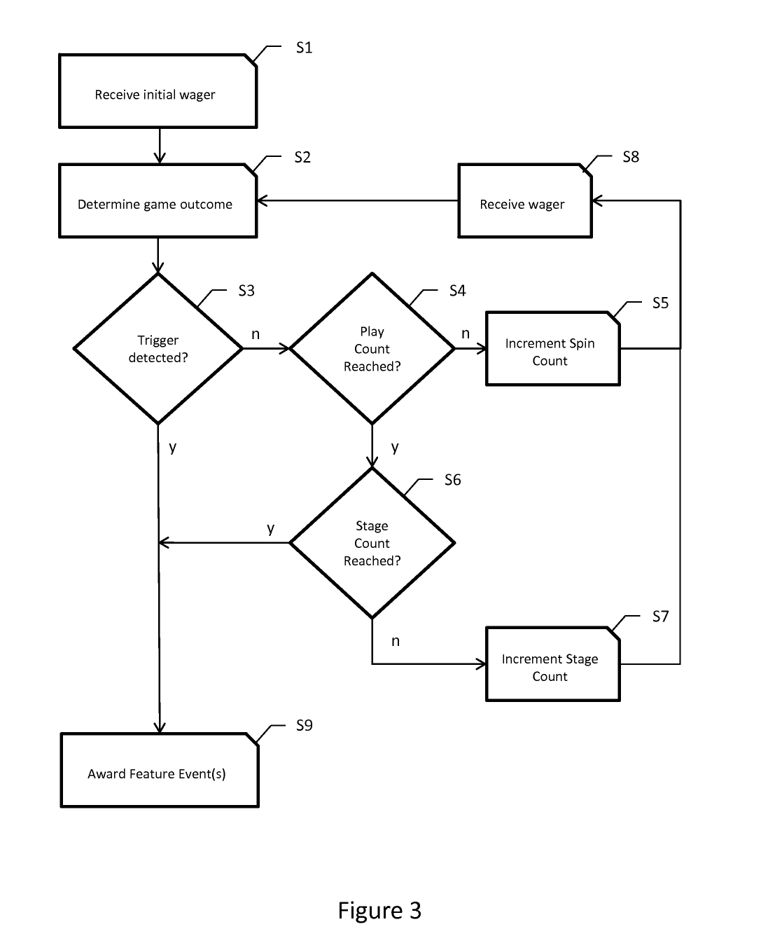

A specific embodiment will now be described with additional reference to the flowchart of FIG. 3. The flowchart assumes that the game is in the form of a reel-type game including four stages (although it will be appreciated that any number of stages could equally apply) corresponding to the seasons of the year, initially starting in winter mode. A feature event (hereafter “free game feature”) in the form of a series of free games is randomly triggerable in each stage, with the number of free games awarded progressively increasing for each stage. The player may be made aware of their progress through the stages by way of a progress meter displayed on the display screen, or by way of some other suitable display mechanism. Alternatively, no progress display may be provided so that the player is not able to determine their progress. The trigger may, for example, be a symbol-driven trigger such as three “season” symbols appearing on a payline that is being played. Progression through each stage is achieved dependent on a predefined gameplay parameter, in this case completing a predefined number of spins of the reel game without the free game feature for that stage having being triggered. Triggering of the free game feature in a particular stage causes the series of free games for that stage, as well as the series of free games for any preceding stages, to be played out before game play is reset to the initial winter stage. If the free game feature is not triggered within the final stage the free game feature is forced to trigger in the final stage (e.g. using the “Feature Guarantee” triggering technique as described in Australian Patent No 2004281073 entitled “Gaming Apparatus and Systems”, the contents of which are incorporated herein by reference), resulting in the series of free games for all preceding stages to be played out before play returns to the initial stage. It will be appreciated that embodiments may not incorporate the forced feature trigger such that play simply returns to the initial stage without any free games being awarded. It will also be appreciated that in certain embodiments play may be reset to a stage other than the initial stage. For example, a random determination may be made as to whether play is to be reset to the initial stage or to some other stage.

At step S1 a player places a main game wager in order to play the multi-stage reel game on the EGM 1. Depending on the desired implementation, the player may also be required to place a wager which is supplementary to the main game wager in order to be eligible to be awarded the free game feature(s). Still at step S1 the stage count is set to “1” which corresponds to the initial winter stage.

At step S2, a game outcome for the stage is determined (with the aid of the RNG 26) and the result displayed to the player.

At step S3, the trigger module 24 evaluates the game outcome to ascertain whether the free game feature trigger occurred. If the trigger did not occur then the process moves to step S4 where the count module 25 evaluates whether the spin count has reached a predefined threshold (in this case being 99 spins). If the spin count threshold has not been reached then the spin count is incremented (step S5) and play returns to step S2 in response to the player placing a further wager at step S8. If at step S4 the count module 25 determines that the spin count has reached the threshold then the count module 25 determines whether the stage count has been reached (step S6). If the stage count has not been reached then the stage count is incremented at step S7 (i.e. so as to cause the game to move to the next seasonal stage) and play returns to step S2 in response to the player placing a further wager (step S8). Alternatively, if the stage count has been reached (i.e. the player has reached the end of the autumn stage), then play moves to step S9 as described below.

Returning to decision step S3, in the event that a trigger is detected then the award module 28 evaluates the number of stages that have been played and initiates an award sequence which involves awarding each of the free game features for all played stages (step S9). The free game features could, for example, be played out in sequence (e.g. starting with the free game feature for the initial winter stage, or starting with the feature of the last stage reached) or being played out concurrently (e.g. with the free game features being played out at the same time on a partitioned game screen, or on separate display screens, or played out in one free game series in which different rules may apply to sub-sets of the series based on the stages reached). Once the free game features for all played stages have finished playing (with any resulting prizes awarded), play is returned to step S1 with both the stage and spin count reset.

In an alternative embodiment to that described above, the feature events for each stage may be of different types. For example, the feature event associated with a first stage may be a series of free games, the feature event for the second stage may be a reel re-spin feature, the feature event for the third stage may be an instant prize, etc. It will be understood that the form of feature event should not be seen as being limited to those events described above and could be any form of in-game feature or externally triggered and awarded feature (e.g. the triggering of a jackpot prize such as a mystery jackpot prize, etc.), depending only on the desired implementation.

It will also be appreciated that the gameplay criterion for stage progression could be any suitable criterion. For example, the criterion could be that the player has wagered a predefined amount of credits or has simply been playing the game for some predefined play period. In this example the predefined amount of credits may be, for example, a set amount or may be variably determined according to some random means, such as a probability schedule accessed by the game control means at some point during play or upon a feature trigger occurrence, or after completion of a feature sequence. In another non limiting example, the criterion could be based on a random determination (e.g. the stage trigger could be set in a manner similar to the way a mystery jackpot is triggered, such as randomly determined before, during or after a play of the game, or upon the player reaching a predefined point of play, where that predefined point is not displayed to them). Other such criterions are within the purview of the skilled person.

It will also be appreciated that certain game play parameters for each stage may vary from one stage to the next (e.g. additional feature trigger symbols may be added to the symbol set for each successive stage, or symbols may be deleted, or both). Further, the actual games played in each stage may take on an entirely different form (e.g. a first stage could be a reel-type game, a second game could be a card game and so on). Equally, a return to player percentage for the various stages could progressively increase or remain the same depending on the desired implementation.

In yet another alternative embodiment, rather than all of the feature events being played for each played stage upon the trigger occurring, the game may instead be able to play out a single feature event which incorporates certain aspects of feature events associated with preceding stages. For example, bonus, wild or paying symbols that may be specific to a particular stage may be added to a feature event triggered in a later stage, and/or paying combinations applicable to a particular stage may be incorporated in a feature event triggered in a later stage, and/or bonus “second screen”, re-spin and other “feature within feature” events that may be triggerable while within a feature and which may normally be applicable to a particular stage may be incorporated in a feature event triggered in a later stage. Alternatively, the single feature event may have one or more play parameters which are set based on how many stages have been played by the player. For example, where the feature event is a series of free games, the number of free games awarded may in part depend on how many stages have been played. Other non-limiting examples include increasing or changing the prize multiplier applied to prizes during the feature event based on how many stages have been played, and/or increasing or changing the number or function of wild symbols based on how many stages have been played.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by a person skilled in the art.

What is claimed is:

1. A method of gaming comprising:
receiving at least one of a coin, token, game credit and bank note to start a wager game;
displaying play of the wager game comprising a main game having a plurality of stages with progression through the stages being triggered responsive to determining that a predefined gameplay criteria has been met, each of the stages being associated with a feature event that is awardable to the player in response to a randomly occurring trigger being determined during play of the corresponding stage; and
in response to determining the randomly occurring trigger in a second or subsequent stage of the main game, awarding the feature event associated with the second or subsequent stage in addition to the feature event associated with each preceding stage, wherein the feature events are awarded to the player in sequence and wherein following the awarding of the final feature event in the sequence game play is reset to the first of the plurality of stages.

2. A method according to claim 1, wherein a value or potential value of the feature event increases with each stage.

3. A method according to claim 1, wherein the predefined gameplay criteria is that a particular game outcome has either occurred or not occurred during play of the respective stage.

4. A method according to claim 1, wherein the predefined gameplay criteria is that a predefined amount of gameplay has occurred, the predefined amount of gameplay relating to at least one of a number of games played by the player and an accumulated wager amount over a predefined period.

5. A method according to claim 1, further comprising forcing the feature event to be awarded in the final stage of the game after a predefined amount of gameplay has been reached without the randomly occurring trigger being determined.

6. A method according to claim 1, wherein a play parameter for an awarded feature event is set in dependence on at least one of a number of stages that have been played at the time the trigger was determined and a characteristic of a feature event associated with a previous stage.

7. A method according claim 1, wherein a play parameter for a feature event associated with one of the stages is different to a play parameter for a feature event associated with another one of the stages.

8. A method according to claim 1, wherein the feature event for each of the stages is the awarding of a number of free games and whereby the number of free games awarded progressively increases with each stage.

9. A method according to claim 1, further comprising requiring a player to place a wager which is supplementary to a wager placed on the game in order to be eligible to be awarded one or more of the feature events in response to a single determination that the trigger for a particular stage has occurred.

10. Gaming apparatus comprising:
a component for receiving at least one of a coin, token, game credit and bank note to start play of a main game;
a display module operable to display play of the main game having a plurality of stages with progression through each stage being triggered in response to determining that a predefined gameplay criteria has been met, each of the stages being associated with a feature event that is awardable to the player in response to a randomly occurring trigger event being determined;
an award module operable to monitor for the occurrence of the randomly occurring trigger and in response to the trigger occurring in a second or subsequent stage, awarding the associated feature event as well as awarding the feature event for each preceding stage in an award sequence and wherein game play is reset to the first of the plurality of stages responsive following the last feature event in the sequence being awarded.

11. A gaming apparatus according to claim 10, wherein a value or potential value of the feature event increases with each stage.

12. A gaming apparatus according to claim 10, wherein the predefined gameplay criteria is that at least one of (a) a particular game outcome has been achieved during play of the respective stage and (b) a predefined amount of gameplay has occurred.

13. A gaming apparatus according to claim 12, wherein the predefined amount of gameplay is associated with at least one of the number of games played by the player and an accumulated wager amount for a predefined period of gameplay.

14. A gaming apparatus according to claim 10, wherein the award module is further operable to force the feature event to be awarded in the final stage of the game after a predefined amount of gameplay has been reached without the trigger occurring.

15. A gaming apparatus according to claim 10, wherein the award module is operable to award the feature event(s) in succession during the single award sequence.

16. A gaming apparatus according to claim 10, wherein the feature event for each of the stages is the awarding of a number of free games and wherein the number of free games awarded progressively increases with each stage.

17. A gaming system comprising:
a gaming terminal implementing a display and having a component for receiving at least one of a coin, token, game credit and bank note to start play of a main game;
a gaming controller comprising: a display module operable to cause the gaming terminal display to display play of the main game having a plurality of progressive stages with progression through each stage being triggered in response to determining that a predefined gameplay criteria has been met, each of the stages being associated with a feature event that is awarded to the player in response to a randomly occurring trigger being determined during play of the corresponding stage; and
an award module operable to monitor for the randomly occurring trigger and in response to determining the trigger in a second or subsequent stage, awarding the associated feature event for that stage as well as awarding the feature event for each preceding stage in an award sequence and wherein game play is reset to the first of the plurality of stages following the awarding of the last feature event in the sequence.
